(19) United States
(12) Patent Application Publication
(10) Pub. No.: US 2005/0172136 A1
(43) Pub. Date: Aug. 4, 2005

(54) Apparatus and method for updating copy control information of input data

(75) Inventors: Hee-chul Han, Suwon-si (KR); Yun-sang Kim, Suwon-si (KR); Yang-lim Choi, Seongnam-si (KR); Sung-hyu Han, Seoul (KR); Yong-kuk You, Seoul (KR); Jung-hyeob Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/045,048

(22) Filed: Jan. 31, 2005

(30) Foreign Application Priority Data
Feb. 2, 2004 (KR) 10-2004-0006594

(51) Int. Cl. H04L 9/00

(52) U.S. Cl. 713/182

(57) ABSTRACT

An apparatus and method for updating copy control information. The apparatus and method can update copy control information of input data with user-defined copy control information. The apparatus includes a copy control information detection unit, which detects copy control information from input data; a copy control information input unit, which receives user-defined copy control information from a user; and a copy control information update unit, which updates the copy control information of the input data with the user-defined copy control information. The copy control information update unit may update the copy control information of the input data with the user-defined copy control information only when the user-defined copy control information imposes a stricter restriction on copying the input data than the copy control information of the input data does.

### BACKGROUND OF THE INVENTION

This application claims the priority of Korean Patent Application No. 2004-6594, filed on Feb. 2, 2004, in the Korean Intellectual Property Office, the disclosure of which is incorporated herein in its entirety by reference.

1. Field of the Invention

The present invention relates to an apparatus and method for updating copy control information attached to digital contents, which allow a user to arbitrarily update the copy control information.

2. Description of the Related Art

Digital contents, such as AV streams, including audio data and video data, and software programs, executed by digital data processing apparatuses (e.g., computers) to output predetermined data, can be unlimitedly copied without deterioration of quality. Accordingly, it has become more of a trend to attach copy control information indicating whether to allow or prevent the copying of digital contents to the digital contents.

Copy control information, which is generally 2 bits long, can be attached to nearly all types of digital contents at the request of manufacturers of the digital contents. Referring to FIG. 1, if a copy control information code of digital contents is set to “00”, the digital contents are not encrypted, and they can be copied an unlimited number of times. If the copy control information code of the digital contents is set to “01”, the digital contents are encrypted but still can be copied an unlimited number of times. If the copy control information code of the digital contents is set to “10”, the digital contents are encrypted and can be copied only one time, in which case, once the digital contents are copied, the copy control information code of the digital contents is updated from “10” to “11” such that the digital contents cannot be copied any longer. If the copy control information code of the digital contents is set to “11”, the digital contents are encrypted, and they cannot be copied at all. The attachment of such copy control information to the digital contents is prescribed in MPEG standards or digital video standards.

For example, if a DVD recording apparatus finds, in a digital video stream, copy control information having a data value corresponding to a “never copy” state, the DVD recording apparatus stops recording the digital video stream. If the DVD recording apparatus finds, in the digital video stream, copy control information having a data value corresponding to a “copy once” state, the DVD recording apparatus records the digital video stream after updating the copy control information to the data value corresponding to the “never copy” state.

In the meantime, a conventional data recording apparatus generally does not attach copy control information to personal information when recording the personal information on a recording medium or attaches copy control information having a copy control information code of “00” or “01” to the personal information. However, in order to prevent the personal information from being illegally distributed, it is preferable to attach copy control information to the personal information, and it is more preferable to impose a stricter restriction on a recording medium, on which the personal information is recorded together with the copy control information, as to the degree to which copying the personal information is restricted. On the contrary, sometimes, there is a need to lower the degree to which copying the personal information is restricted by updating the copy control information attached to the personal information with less restrictive copy control information.

### SUMMARY OF THE INVENTION

The present invention provides an apparatus and method for updating copy control information, which can update copy control information of input data with user-defined copy control information input by a user.

The present invention provides an apparatus and method for updating copy control information, which can update copy control information of input data with user-defined copy control information input by a user, only if the input data is not user-defined data and the user-defined copy control information imposes a stricter restriction on the copying of the input data than the copy control information of the input data does.

According to an aspect of the present invention, there is provided an apparatus for updating copy control information. The apparatus includes a copy control information detection unit, which detects copy control information from input data; a copy control information input unit, which receives user-defined copy control information from a user; and a copy control information update unit, which updates the copy control information of the input data with the user-defined copy control information.

The copy control information update unit may update the copy control information of the input data with the user-defined copy control information only when the user-defined copy control information imposes a stricter restriction on copying the input data than the copy control information of the input data does.

If the input data is not user-defined data, the copy control information update unit updates the copy control information of the input data with the user-defined copy control information only when the user-defined copy control information imposes a stricter restriction on copying the input data than the copy control information of the input data does.

The copy control information update unit may include a data encryption and decryption portion, which encrypts or decrypts the input data with the updated copy control information.

The input data may be input from a data provider.

According to another aspect of the present invention, there is provided a method of updating copy control information. The method involves (a) detecting copy control information from input data; (b) receiving user-defined copy control information from a user; and (c) updating the copy control information of the input data with the user-defined copy control information.

In (c), the copy control information of the input data may be updated with the user-defined copy control information only when the user-defined copy control information imposes a stricter restriction on copying the input data than the copy control information of the input data does.

In (c), if the input data is not user-defined data, the copy control information of the input data is updated with the user-defined copy control information only when the user-defined copy control information imposes a stricter restriction on copying the input data than the copy control information of the input data does.

The method may further include encrypting or decrypting the input data with the updated copy control information if an encryption state of the input data has changed in (c) because of the updating of the copy control information of the input data with the user-defined copy control information.

Operation (b) may involve providing a user interface screen such that the user can select the user-defined copy control information on the user interface screen.

According to still another aspect of the present invention, there is provided a computer-readable recording medium storing a program for performing a method of updating copy control information. The method involves (a) detecting copy control information from input data; (b) receiving user-defined copy control information from a user; and (c) updating the copy control information of the input data with the user-defined copy control information.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating copy control information attached to data;

FIG. 2 is a block diagram of a data recording apparatus that includes an apparatus for updating copy control information according to an exemplary embodiment of the present invention;

FIG. 3 is a diagram illustrating a user interface screen provided by the apparatus for updating copy control information according to an exemplary embodiment of the present invention;

FIG. 4 is a flowchart of a method of updating copy control information according to an exemplary embodiment of the present invention;

FIG. 5 is a flowchart of a method of updating copy control information according to another exemplary embodiment of the present invention; and

FIG. 6 is a flowchart of a method of updating copy control information according to still another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

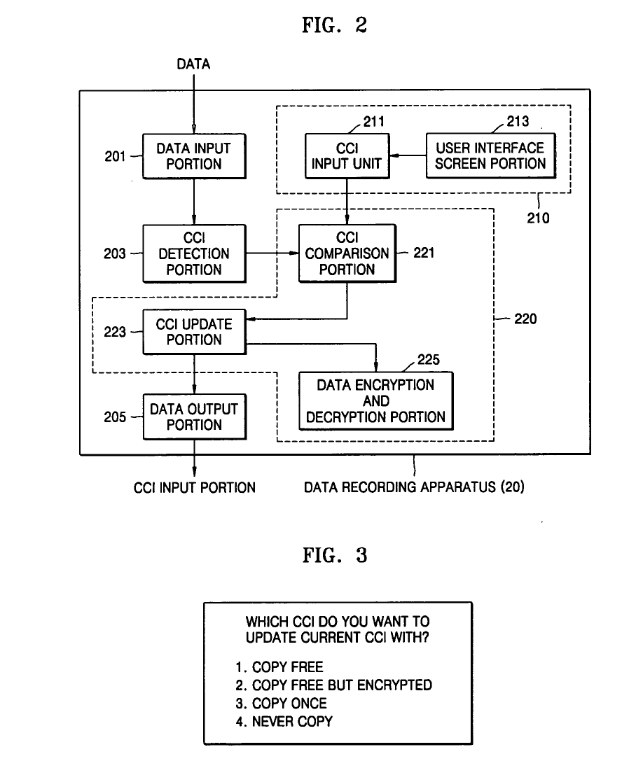

FIG. 2 illustrates a data recording apparatus 20 that includes an apparatus for updating copy control information according to an exemplary embodiment of the present invention. Referring to FIG. 2, the data recording apparatus 20 includes a data input portion 201, which receives data from an external data provider, a copy control information detection portion 203, which detects copy control information from the received data, a copy control information input portion 211, which receives copy control information (hereinafter, referred to as user-defined copy control information) from a user, a user interface screen portion 213, which provides a user interface screen so that the user can select the user-defined copy control information on the user interface screen, a copy control information comparison portion 221, which compares the copy control information received by the copy control information input portion 211 with the copy control information detected by the copy control information detection portion 203 and outputs a comparison result, a copy control information update portion 223, which updates the copy control information detected from the received data based on the comparison result output from the copy control information comparison portion 221, a data encryption and decryption portion 225, which, if necessary, encrypts or decrypts the data with the updated copy control information and outputs an encryption or decryption result, and a data output portion 205, which outputs data output from the data encryption and decryption portion 225 or output from the copy control information update portion 223. The copy control information input portion 211 and the user interface screen portion 213 constitute a copy control information input unit 210, the copy control information comparison portion 221, the copy control information update portion 223, and the data encryption and decryption portion 225 constitute a copy control information update unit 220. The copy control information detection portion 203, the copy control information input unit 210, and the copy control information update unit 220 constitute the apparatus for updating copy control information according to an exemplary embodiment of the present invention.

The data input portion 201 receives data from various external data providers, such as a PC, a digital camcorder, and a DVD recording and reproducing apparatus. The data input portion 201 may receive data from such various external data providers via a wide area network. The data input portion 201 may read data from a recording medium, such as a DVD, with the help of a disk drive disposed at the data recording apparatus 20. Therefore, the data input portion 201 may be a communication interface or a disk reader depending on the type of an external data provider, from which it receives data.

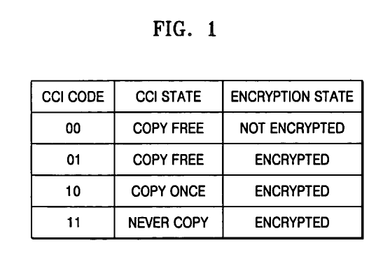

The copy control information detection portion 203 detects copy control information from the data received by the data input portion 201. In digital content, copy control information bits are recorded at a predetermined location defined by the MPEG or digital video format, for example, at a header of input data. Therefore, the copy control information detection portion 203 detects the copy control information, like the one illustrated in FIG. 1, from the received data. In some cases, the copy control information detection portion 203 may detect a user-defined data identification flag bit from the received data, which will be described in detail later.

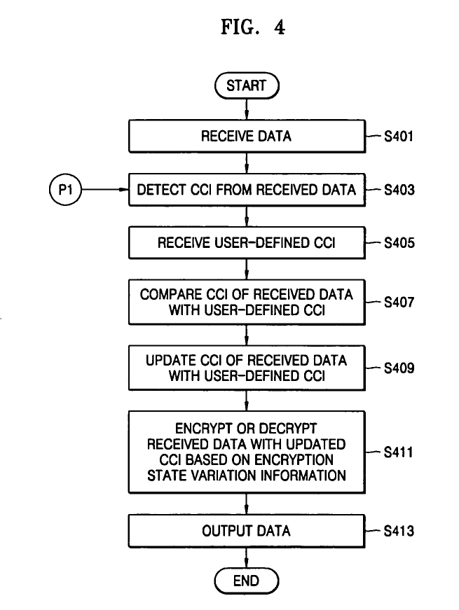

The copy control information input portion 211 receives the copy control information detected from the received data and receives an update command from a manipulation panel (not shown) in order to update the detected copy control information with the user-defined copy control information input by the user. The user interface screen portion 213 provides a user interface screen, as shown in FIG. 3, such that the user can input copy control information by using the manipulation panel. The user interface screen portion 213 may provide another user interface screen for inputting the update command. The user interface screen portion 213 may provide a different user interface screen from the one illustrated in FIG. 3 according to a copy control information update policy, which will be described more fully later.

The copy control information comparison portion 221 receives the copy control information from the copy control information detection portion 203 and from the copy control information input portion 211, compares the received copy control information, and outputs the comparison results to the copy control information update portion 223. The comparison results include copy control information code variation information that comprises copy control information state variation information and encryption state variation information. The copy control information state variation information specifies a result of comparing a copy control state of the copy control information of the received data with a copy control state of the user-defined copy control information, and the encryption state variation information specifies a result of comparing an encryption state of the copy control information of the received data with an encryption state of the user-defined copy control information.

The copy control information update portion 223 updates the copy control information of the received data based on the comparison result output from the copy control information comparison portion 221. Here, the copy control information of the received data may be updated in various manners depending on which copy control information update policy the data recording apparatus 20 adopts. For example, the copy control information comparison portion 221 may adopt a copy control information update policy (hereinafter, referred to as a first copy control information update policy) of replacing the copy control information of the received data with the user-defined copy control information regardless of the comparison result or may adopt a copy control information update policy (hereinafter, referred to as a second copy control information update policy) that updates the copy control information of the received data with the user-defined copy control information only if the user-defined copy control information imposes a stricter restriction on copying the received data than the copy control information of the received data does. In FIG. 1, the higher data value the copy control information has, the more severely the copying of corresponding data is restricted.

Given that digital contents can be copied indiscriminately and unlimitedly, there is a strong need to protect some digital contents for personal or business concerns. To this end, recent digital data recording apparatuses, such as camcorders or DVD recorders, may have a function of setting an identification bit (hereinafter, referred to as a user-defined data identification flag bit) in a header of data when a user attempts to record the data for personal concerns. Therefore, a copy control information update policy (hereinafter, referred to as a third copy control information update policy) may be adopted so that, if the received data is user-defined data, i.e., if the user holds the copyright on the received data or is authorized to freely update the copy control information of the received data, the first copy control information update policy can be adopted, and, otherwise, the second copy control information update policy can be adopted.

In a case where the data recording apparatus 20 adopts the first copy control information update policy, the copy control information comparison portion 221 compares the encryption state of the copy control information of the received data with the encryption state of the user-defined copy control information, transmits the encryption state variation information to the copy control information update portion 223. The copy control information update portion 223 updates the copy control information of the received data with the user-defined copy control information. In a case where the data recording apparatus 20 adopts the second copy control information update policy, the copy control information comparison portion 221 compares the copy control information of the received data with the user-defined copy control information and transmits the copy control information code variation information that comprises the encryption state variation information and the copy control information state variation information to the copy control information update portion 223. The copy control information portion 223 updates the copy control information of the received data with the user-defined copy control information only if the user-defined copy control information imposes a stricter restriction on the copying of the received data than the copy control information of the received data does. In a case where the data recording apparatus 20 adopts the third copy control information update policy, the user-defined data identification flag bit indicating whether the received data is user-defined data is inserted into the received data. Then, the data recording apparatus 20 detects the user-defined data identification flag bit from, for example, the copy control information detection portion 203, and updates the copy control information of the received data according to the first or second copy control information update policy. More specifically, the copy control information detection portion 203 detects the user-defined data identification flag bit from the received data together with the copy control information, processes the received data according to the first copy control information update policy if the received data is user-defined data (i.e., if the user-defined data identification flag bit is set to ‘1’), and processes the received data according to the second copy control information update policy if the received data is not user-defined data (i.e., if the user-defined data identification flag bit is set to ‘0’).

If the copy control information of the received data indicates a “copy free” state and a “non-encrypted” state and the copy control information update portion 223 updates the copy control information of the received data with stricter copy control information, the data encryption and decryption portion 225 can encrypt the received data using a predetermined encryption algorithm, such as a data encryption standard (DES) algorithm or an advanced encryption standard (AES) algorithm. If a copy control information code of the received data is set to a data value of “00” and the copy control information update portion 223 updates the copy control information code of the received data from “00” to anything but “00”, the data encryption and decryption portion 225 can decrypt the received data using a predetermined decryption algorithm, such as the DES or AES algorithm.

The data output portion 205 outputs the received data, which has already been updated or is yet to be updated, to the outside and may output the received data encrypted or decrypted by the data encryption and decryption portion 225 to the outside. The data output portion 205 may be a communication interface or a data recorder depending on the type of data output therefrom. Therefore, in the case of reading data from a recording medium, such as a DVD, and recording the data with the updated copy control information on the recording medium, the data input portion 201 and the data output portion 205 may realize a data reader and a data recorder, respectively. The data with the updated copy control information may be overwritten on the recording medium where the data with the copy control information yet to be updated was recorded or may be written on the recording medium separately from the data with the copy control information yet to be updated. The data with the updated copy control information may be written on a recording medium other than the recording medium on which the data with the copy control information yet to be updated is recorded.

An optical disk recording and reproducing apparatus records data on or reads data from an optical disk, such as a DVD, by rotating the optical disk with the use of a spindle motor and radiating laser beams on the optical disk with the use of an optical head.

The operation of the data recording apparatus 20 will now be described.

First, let us assume that the data recording apparatus 20 adopts the first copy control information update policy, under which copy control information of input data is updated with user-defined copy control information regardless of whether the copy control information of the input data imposes a stricter regulation on copying the input data. A user inputs data with copy control information to be updated and user-defined copy control information to the data recording apparatus 20 using a predetermined manipulation panel. The data input portion 201 receives the data, and the copy control information input portion 211 receives the user-defined copy control information. The copy control information detection portion 203 detects the copy control information of the received data. The copy control information comparison portion 221 receives the copy control information of the received data from the copy control information detection portion 203 and receives the user-defined copy control information from the copy control information input portion 211. The copy control information comparison portion 221 compares the copy control information of the received data with the user-defined copy control information and outputs encryption state variation information to the copy control information update portion 223 as a comparison result. The copy control information update portion 223 updates the copy control information of the received data with the user-defined copy control information.

If a copy control information code of the received data is updated from “00” to anything but “00”, the data encryption and decryption portion 225 encrypts the received data. On the other hand, if the copy control information code of the received data is updated from anything but “00” to “00”, the data encryption and decryption portion 225 decrypts the received data. In addition, if there is no need to encrypt or decrypt the received data, i.e., if the copy control information code of the received data is updated from anything but “00” to anything else but “00”, the data encryption and decryption portion 225 outputs the received data with the updated copy control information to the outside.

Second, if the data recording apparatus 20 adopts the second copy control information update policy, the copy control information comparison portion 221 compares the copy control information of the received data with the user-defined copy control information and outputs copy control information code variation information that comprises copy control information state variation information and encryption state variation information to the copy control information update portion 223 as a comparison result. The copy control information update portion 223 determines, based on the copy control information code variation information received from the copy control information comparison portion 221, whether the user-defined copy control information imposes a stricter restriction on the copying of the received data than the copy control information of the received data does. If the user-defined copy control information imposes a stricter restriction on the copying of the received data than the copy control information of the received data does, the copy control information update portion 223 updates the copy control information of the received data with the user-defined copy control information. Otherwise, the copy control information update portion 223 does not update the copy control information of the received data with the user-defined copy control information. If the copy control information update portion 223 decides not to update the copy control information of the received data with the user-defined copy control information, the copy control information update portion 223 outputs the received data to the outside and performs the same operation as it does when the data recording apparatus 20 adopts the first copy control information update policy. According to the second copy control information update policy, a copy control information state of the received data can be updated from ‘copy free’ to ‘never copy’ but cannot be updated from ‘never copy’ to ‘copy free’ or ‘copy once’.

Third, if the data recording apparatus 20 adopts the third copy control information update policy, the copy control information detection portion 203 detects a user-defined data identification flag bit from the received data. Then, the copy control information comparison portion 221 and the copy control information update portion 223 operate according to the first or second copy control information update policy. In this case, it is determined, based on the detection results, whether the copy control information comparison portion 221 and the copy control information update portion 223 will follow the first or second copy control information update policy.

FIG. 4 is a flowchart of the operation of the data recording apparatus 20 when the data recording apparatus 20 adopts the first copy control information update policy. Referring to FIG. 4, the data input portion 201 receives data in operation S401. In operation S403, the copy control information detection portion 203 detects copy control information of the received data. In operation S405, the copy control information input portion 211 receives user-defined copy control information. In operation S407, the copy control information comparison portion 221 compares an encryption state of the copy control information of the received data with an encryption state of the user-defined copy control information and transmits encryption state variation information to the copy control information update portion 223 as a comparison result. In operation S409, the copy control information update portion 223 updates the copy control information of the received data with the user-defined copy control information. In operation S411, the data encryption and decryption portion 225 encrypts or decrypts the received data with the updated copy control information with reference to the encryption state variation information. More specifically, in operation S411, the data encryption and decryption portion 225 encrypts the received data with the updated copy control information if a copy control information code of the received data is updated from “00” to anything but “00” and decrypts the received data with the updated copy control information if the copy control information code of the received data is updated from anything but “00” to “00”. In operation S413, the data output portion 205 outputs the received data with the updated copy control information, which has been encrypted or decrypted in operation S411 or is yet to be encrypted or decrypted, to the outside.

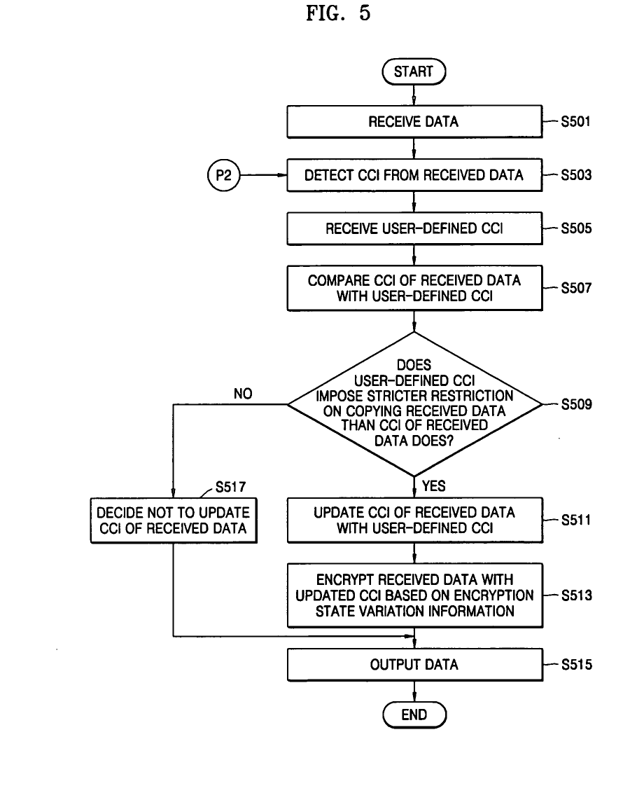

FIG. 5 is a flowchart of the operation of the data recording apparatus 20 when the data recording apparatus 20 adopts the second copy control information update policy. Operations S501, S503, and S505 of FIG. 5 are the same as operations S401, S403, and S405 of FIG. 4, and thus their descriptions will be omitted.

In operation S507, the copy control information comparison portion 221 compares the copy control information of the received data with the user-defined copy control information and outputs copy control information code variation information that comprises copy control information state variation information and encryption state variation information as a comparison result. In operation S509, the copy control information update portion 223 determines, based on the copy control information code variation information, whether the user-defined copy control information imposes a stricter regulation on the copying of the received data than the copy control information of the received data does. If the user-defined copy control information imposes a stricter regulation on the copying of the received data than the copy control information of the received data does, the copy control information update portion 223 updates the copy control information of the received data with the user-defined copy control information in operation S511. Otherwise, the copy control information update portion 223 decides not to update the copy control information of the received data in operation S517. In operation S513, the data encryption and decryption portion 225 encrypts the received data with the updated copy control information if a copy control information code of the received data is updated from “00” to anything but “00”. In operation S515, the data output portion 205 outputs the encryption result obtained in operation S513 to the outside.

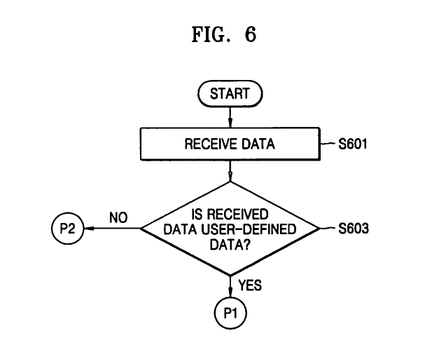

FIG. 6 is a flowchart of the operation of the data recording apparatus 20 when the data recording apparatus 20 adopts the third copy control information update policy. Referring to FIG. 6, in operation S601, the data input portion 201 receives data. In operation S603, the copy control information detection portion 203 detects a user-defined data identification flag bit from the received data and determines whether the received data is user-defined data by referring to the user-defined data identification flag bit. If the user-defined data identification flag bit is set to “1”, the copy control information detection portion 203 determines that the received data is user-defined data, and the operation proceeds to operation S403 of FIG. 4 such that the data recording apparatus 20 operates according to the first copy control information update policy. On the other hand, if the user-defined data identification flag bit is set to “0”, the copy control information detection portion 203 determines that the received data is not user-defined data, and the operation proceeds to operation S503 of FIG. 5 such that the data recording apparatus 20 operates according to the second copy control information update policy.

The present invention provides a computer-readable recording medium, on which a method of updating copy control information according to an exemplary embodiment of the present invention is recorded. The computer-readable recording medium includes a magnetic recording medium, such as a hard disk drive (HDD) or a floppy disk, an optical recording medium, such as a CD or a DVD, and a carrier wave, such as data transmission through the Internet.

The exemplary embodiments of the present invention have been described on the assumption that data originally has copy control information bits therein. However, data may not have copy control information bits therein, in which case, the data recording apparatus 20 can attach the copy control information bits to a predetermined portion of the data. In addition, if the data recording apparatus 20 receives analog data, it may include an analog-to-digital converter in order to convert the analog data into digital data.

As described above, according to the present invention, it is possible to update copy control information of input data with user-defined copy control information.

In an exemplary embodiment of the present invention, the copy control information of the input data is not updated with the user-defined copy control information unless the input data is user-defined data and the user-defined copy control information imposes a stricter restriction on copying the input data than the copy control information of the input data. Therefore, it is possible to prevent the input data from being illegally distributed by non-authorized users.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for updating copy control information comprising:
a copy control information detection unit, which detects copy control information from input data;
a copy control information input unit, which receives user-defined copy control information from a user; and
a copy control information update unit, which updates the copy control information of the input data with the user-defined copy control information.

2. The apparatus of claim 1, wherein the copy control information update unit updates the copy control information of the input data with the user-defined copy control information only when the user-defined copy control information imposes a stricter restriction on copying the input data than the copy control information of the input data does.

3. The apparatus of claim 1, wherein if the input data is not user-defined data, the copy control information update unit updates the copy control information of the input data with the user-defined copy control information only when the user-defined copy control information imposes a stricter restriction on copying the input data than the copy control information of the input data does.

4. The apparatus of claim 1, wherein the copy control information update unit comprises a data encryption and decryption portion, which encrypts or decrypts the input data with the updated copy control information.

5. The apparatus of claim 1, wherein the input data is read from a recording medium.

6. The apparatus of claim 1, wherein the input data is input from a data provider.

7. The apparatus of claim 1, wherein the input data with the updated copy control information is recorded on a recording medium.

8. The apparatus of claim 1, wherein the input data with the updated copy control information is transmitted to a data provider.

9. The apparatus of claim 1, wherein the copy control information input unit comprises a user interface screen portion, which provides a user interface screen for selecting, by a user, the user-defined copy control information on the user interface screen.

10. A method of updating copy control information comprising:
(a) detecting copy control information from input data;
(b) receiving user-defined copy control information from a user; and
(c) updating the copy control information of the input data with the user-defined copy control information.

11. The method of claim 10, wherein in (c), the copy control information of the input data is updated with the user-defined copy control information only when the user-defined copy control information imposes a stricter restriction on copying the input data than the copy control information of the input data does.

12. The method of claim 10, wherein in (c), if the input data is not user-defined data, the copy control information of the input data is updated with the user-defined copy control information only when the user-defined copy control information imposes a stricter restriction on copying the input data than the copy control information of the input data does.

13. The method of claim 10 further comprising encrypting or decrypting the input data with the updated copy control information if an encryption state of the input data has changed in (c) because of the updating of the copy control information of the input data with the user-defined copy control information.

14. The method of claim 10, wherein before (a), the input data is read from a recording medium.

15. The method of claim 10, wherein before (a), the input data is input from a data provider.

16. The method of claim 10, wherein after (c), the input data with the updated copy control information is recorded on a recording medium.

17. The method of claim 10, wherein after (c), the input data with the updated copy control information is transmitted to a data provider.

18. The method of claim 10, wherein (b) comprises providing a user interface screen for selecting, by a user, the user-defined copy control information on the user interface screen.

19. A computer-readable recording medium, on which is stored a program for performing a method of updating copy control information, the method comprising:
(a) detecting copy control information from input data;
(b) receiving user-defined copy control information from a user; and
(c) updating the copy control information of the input data with the user-defined copy control information.

20. The computer-readable recording medium of claim 19, wherein in (c), if the input data is not user-defined data, the copy control information of the input data is updated with the user-defined copy control information only when the user-defined copy control information imposes a stricter restriction on copying the input data than the copy control information of the input data does.
